(19) United States
(12) Patent Application Publication
(10) Pub. No.: US 2008/0154939 A1
(43) Pub. Date: Jun. 26, 2008

(54) Information transfer from object-oriented repository to relational database

(75) Inventors: Eugene Otto Mutschler, San Clemente, CA (US); Joseph Peter Stefaniak, San Clemente, CA (US); Douglas Marshall Tolbert, Newport Beach, CA (US); Mahmood Mac Vazehgoo, Laguna Niguel, CA (US)

Correspondence Address: UNISYS CORP., 25725 JERONIMO ROAD, MS400, MISSION VIEJO, CA, 92691, US

(73) Assignee: Unisys Corporation

(21) Appl. No.: 11/644,930

(22) Filed: Dec. 22, 2006

(51) Int. Cl. G06F 17/30

(52) U.S. Cl. 707/102; 707/E17.009

(57) ABSTRACT

An embodiment of the present invention is a technique to transfer information from an object-oriented repository to a relational database. A repository definition file is created from a meta object facility (MOF) modeling tool. A schema file used by a relational database is generated from the repository definition file. A library object code is generated from the repository definition file. Relational data from an object-oriented repository are loaded into the relational database using the library object code.

### BACKGROUND

1. Field of the Invention

Embodiments of the invention relate to the field of software, and more specifically, to object-oriented repositories and relational databases.

2. Description of Related Art

Object-oriented repositories offer various advantages over relational databases when dealing with a dynamic environment. Some of these advantages include: (1) data are stored and accessed as objects, (2) data can be manipulated by programs written in object-oriented languages such as C++, C#, Java, and (3) object-oriented repositories are readily extensible. However, one major problem with object-oriented repositories is that popular database query languages, such as structured query language (SQL), cannot be used with object-oriented repositories.

Many products have needs that can only be addressed by providing a relational database view of their data. For example, queries used to generate reports need to be relational database stored procedures; and products providing data visualization are usually driven by a relational database.

Currently, there is no known technique to transfer the information from an object-oriented repository to a relational database in such a manner that relational queries written in relational query languages, such as SQL, can be used to interrogate the data in the object-oriented repository.

### SUMMARY OF THE INVENTION

An embodiment of the present invention is a technique to transfer information from an object-oriented repository to a relational database. A repository definition file is created from a meta object facility (MOF) modeling tool. A schema file used by a relational database is generated from the repository definition file. A library object code is generated from the repository definition file. Relational data from an object-oriented repository are loaded into the relational database using the library object code.

### BRIEF DESCRIPTION OF THE DRAWINGS

The invention may best be understood by referring to the following description and accompanying drawings that are used to illustrate embodiments of the invention. In the drawings:

FIG. 1A is a diagram illustrating a system in which one embodiment of the invention can be practiced.

FIG. 1B is a diagram illustrating a computer system according to one embodiment of the invention.

FIG. 2 is a flowchart illustrating a process to transfer information from an object-oriented repository to a relational database according to one embodiment of the invention.

FIG. 3 is a flowchart illustrating a process to create a repository definition file according to one embodiment of the invention.

FIG. 4 is a flowchart illustrating a process to generate a schema file according to one embodiment of the invention.

FIG. 5 is a flowchart illustrating a process to generate a library object code according to one embodiment of the invention.

FIG. 6 is a flowchart illustrating a process to load relational database into relational database according to one embodiment of the invention.

FIG. 7 is a flowchart illustrating a process to create a repository according to one embodiment of the invention.

### DESCRIPTION

An embodiment of the present invention is a technique to transfer information from an object-oriented repository to a relational database. A repository definition file is created from a meta object facility (MOF) modeling tool. A schema file used by a relational database is generated from the repository definition file. A library object code is generated from the repository definition file. Relational data from an object-oriented repository are loaded into the relational database using the library object code.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process, which is usually depicted as a flowchart, a flow diagram, a structure diagram, or a block diagram. Although a flowchart may describe the operations as a sequential process, many of the operations can be performed in parallel or concurrently. A loop or iterations in a flowchart may be described by a single iteration. It is understood that a loop index or loop indices or counter or counters are maintained to update the associated counters or pointers. In addition, the order of the operations may be re-arranged. A process terminates when its operations are completed. A process may correspond to a method, a program, a procedure, etc. A block diagram may contain blocks or modules that describe an element, an item, a component, a device, a unit, a subunit, a structure, a method, a process, a function, an operation, a functionality, or a task, etc. A functionality or an operation may be performed automatically or manually. In the following, the term “task” is used to indicate an instance of a process, a program in execution, a job, a thread, a stack, or any basic entity that an operating system uses as part of its scheduling operations.

One embodiment of the invention is a technique to transfer information from an object-oriented repository to a relational database so that data in the repository may be queried by a relational query language, such as SQL. A modeling tool is used to create a repository definition file. A repository generator generates a repository source code using the repository definition file. The repository source code generates an object-oriented repository. A code generator generates a language source code using the repository definition file. The source code is compiled to produce a library object code. A schema generator generates a schema file using the repository definition file. The schema file is used to create a relational database. A loader transforms an instance data file exported by the repository into relational data represented by a relational data structure using the library object code. The loader loads the relational data structure into the relational database. The data may be queried by a relational query support from the relational database.

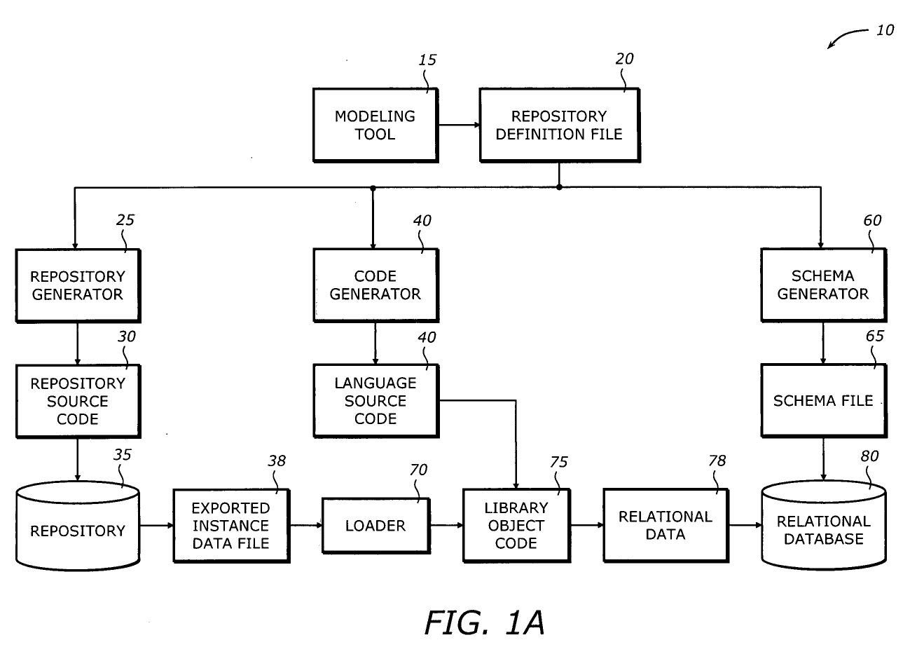

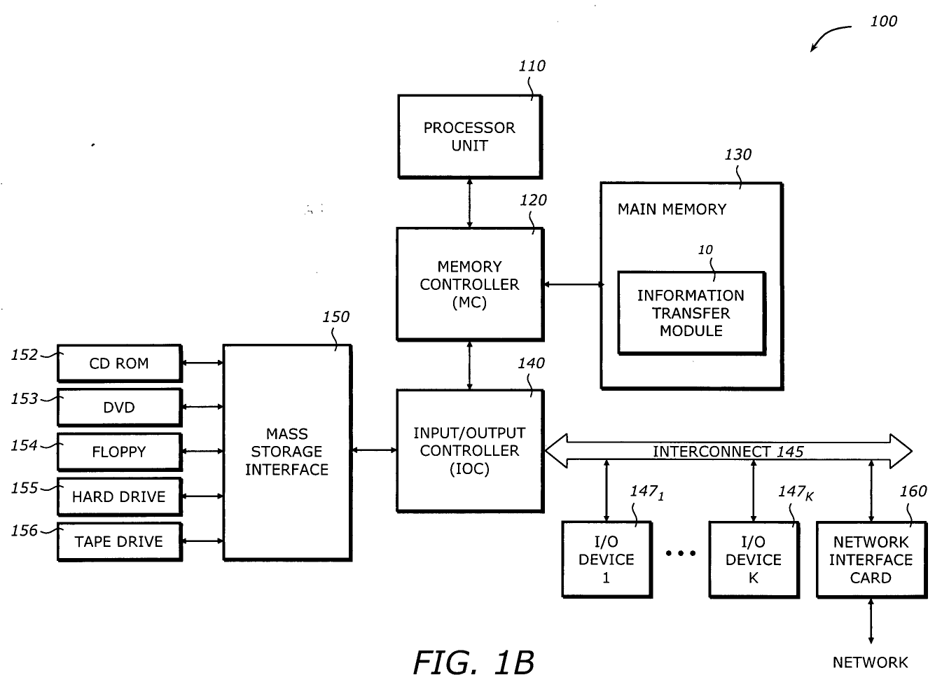

FIG. 1A is a diagram illustrating a system 10 in which one embodiment of the invention can be practiced. The system 10 includes a modeling tool 15, a repository generator 25, a code generator 40, a schema generator 60, and a loader 70.

The modeling tool 15 is a tool to create and manipulate constructs of a model. The model may be exported from one application, imported into another application, rendered into a particular format such as eXtensible Markup Language (XML). In addition, the model may be used to generate application code. Various forms of models may be created including structural models, behavioral models, and data models. In one embodiment, the modeling tool 15 is compliant with a Meta Object Facility (MOF) standard. The MOF is a standard supported by the Object Management Group (OMG) which provides a framework for the description of object classes and their relationships with each other.

There are various versions of the MOF standard, for example, MOF Core Specification, v 2.0, published by OMG, January 2006. The MOF is capable of being implemented by object-oriented modeling tools, providing a convenient means for the development of instances of the MOF. In particular, an object model for an object-oriented repository can be developed using such a tool and, perhaps using the code generation facilities of the tool, can be mechanically generated into the source code for a program to implement the repository.

Building on the MOF, the XML Metadata Interchange format (XMI) is a means of translating a MOF model, or an instance of a MOF model, into an XML file in a manner that preserves information and is understandable by a wide variety of tools. Like the MOF, XMI is an OMG standard. The current version is the MOF 2.0/XMI Mapping Specification, v. 2.1, published by OMG, September 2005. The XMI format is an interchange format, that is, it describes the MOF model instance in such a way that an XMI file produced by one modeling tool can be imported into another MOF-compliant tool without significant loss of information. In its most obvious usage, XMI can be used to transfer models from one modeling tool to another. An XMI file may also be used as input to a language generator to embody a model as a computer program. Another use of an XMI file is as input to a database schema generation tool to embody a model as a database. XMI is not just limited to model descriptions. Since an instance of MOF is also MOF-compliant, XMI may also be used to import or export data to or from MOF instance models.

The modeling tool 15 may be used to create a repository definition file 20. The repository definition file 20 may be a file produced by loading a model of an object-oriented repository into the modeling tool 15 and exporting it to a pre-defined format. In one embodiment, the repository definition file 20 is an XMI file created by the MOF-compliant modeling tool 15. The repository definition file 20 may be used as an input to the repository generator 25, the code generator 40, and the schema generator 60 to generate a repository source code 30, a source code 45, and a schema file 65, respectively. If the modeling tool is not MOF-compliant, certain unified modeling language (UML) modeling tools may be enhanced to support the MOF. An example of such a tool is Rational Rose owned by IBM Corporation, with MOF and XMI support provided in the form of an “addin”.

The model development process is generally an iterative one, involving the phases of loading the model, using the modeling tool 15 to add or modify the classes, attributes, associations, etc, that represent the model of an object-oriented repository, exporting the model to XMI as for the purpose of generating the object-oriented repository, and testing the generated object-oriented repository. The model may be modified when necessary.

The repository generator 25 uses the repository definition file 20 to create the repository source code 30. The repository source code 30 may be run to create the object-oriented repository 35. The object-oriented repository 35 may also be generated directly from the MOF-compliant modeling tool 15 as described above, if the modeling tool 15 provides such capabilities.

The repository 35 may be a database, a storage subsystem, a depository, or any unit that stores data in object-oriented environment. It is desired to view data or information in the repository 35 with standard relational queries. The repository 35 may have an export facility that exports an instance data file 38 in a pre-defined format compatible with the repository definition file 20. In one embodiment, this pre-defined format is the XMI format, or a format that may be transformed into the XMI format. If the repository does not have an XMI export facility, but has an XML export facility instead, the instance data file may be exported from XML to XMI using the eXtensible Stylesheet Transformation Language (XSLT) process. The XSLT standard was created by the World Wide Web Consortium (W3C) as a means for transforming XML files into other formats, including the XMI format. The phrase “XMI exported instance data” refers to both native XMI data and XMI data produced by a transformation processing such as the XSLT.

The code generator 40 generates a library object code 75 from the repository definition file 20. It is possible to define rules for mapping MOF constructs to programming language constructs. This has been done for C++, Java and C#, for example. It is further possible to implement these rules programmatically and thereby create source code in these languages. One method of doing this is to accept as input an XMI description of a MOF model and emit source code that, when compiled, produces a Microsoft Windows dynamic link library (DLL) with entry points corresponding to the MOF constructs in the original MOF model.

In the present invention, the code generator 40 processes the XMI repository definition file 20 to produce a language source code 45 for a library object code 75 that represents the repository model. The language source code 45 is then compiled using an appropriate compiler to produce an object-form library object code 75. The library object code 75 typically is a DLL. The rules for mapping MOF constructs to a programming language may include rules for parsing XMI instance data for the MOF model implemented by the DLL to instantiate instances of the generated classes. Alternatively, a separate XMI parsing product may be used, though the interface to the separate XMI parser should be included. In one embodiment, the code generator 40 generates the source code 45 that handles the bulk of the XMI parsing task. The object code 75 may have different forms in different environments. For example, a C++ source code on Microsoft Windows produces a DLL; on UNIX or Linux, it may produce a Shared Object.

The schema generator 60 processes the XMI repository definition file 20 to produce a schema file 65. Just as it is possible to define rules for mapping MOF constructs to programming languages, it is possible to define rules for mapping these constructs to a relational database schema. The schema file 65 is processed to create a relational database 80. The relational database 80 contains tables that represent the classes, associations and supporting data from the original repository model, in a relational form.

The relational form of a MOF class would include all the attributes of that class in a single table. However, the attributes of the parent class(es) of the class might well be implemented in different tables. This means that a view would need to be developed to make all of the attributes of a class, including its parents, appear to be in a single table. Alternatively, stored procedures may be generated that produce the same effect.

The loader 70 loads relational data from the object-oriented repository 35 into the relational database 80 using the library object code 75. Since the library object code 75 is an instantiation of the MOF repository model, it allows the loader 70 to read an XMI construct from the exported instance data file 38 and create an internal object that instantiates that construct. The loader 70 creates an object data structure representing objects described by the instance data file 38. The loader 70 then traverses the object data structure to visit every object in the objects represented by the object data structure and described by the instance data file 38. It then creates a relational data structure for each visited object and places the relational data structure into the relational database 80. Placing the relational data structure into the relational database 80 may be performed by making a call using an application programming interface (API) provided by the object-oriented repository 35. The loaded relational data may then be queried using whatever relational query support that the relational database 80 provides.

FIG. 1B is a diagram illustrating a computer system 100 according to one embodiment of the invention. The system 100 includes a processor unit 110, a memory controller (MC) 120, a main memory 130, an input/output controller (IOC) 140, an interconnect 145, a mass storage interface 150, input/output (I/O devices 147₁ to 147_{K}, and a network interface card (NIC) 160. The system 100 may include more or less of the above components.

The processor unit 110 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The MC 120 provides control and configuration of memory and input/output devices such as the main memory 130 and the IOC 140. The MC 120 may be integrated into a chipset that integrates multiple functionalities such as graphics, media, isolated execution mode, host-to-peripheral bus interface, memory control, power management, etc. The MC 120 or the memory controller functionality in the MC 120 may be integrated in the processor unit 110. In some embodiments, the memory controller, either internal or external to the processor unit 110, may work for all cores or processors in the processor unit 110. In other embodiments, it may include different portions that may work separately for different cores or processors in the processor unit 110.

The main memory 130 stores system code and data. The main memory 130 is typically implemented with dynamic random access memory (DRAM), static random access memory (SRAM), or any other types of memories including those that do not need to be refreshed. The main memory 130 may include multiple channels of memory devices such as DRAMs. The DRAMs may include Double Data Rate (DDR2) devices with a bandwidth of 8.5 Gigabyte per second (GB/s). In one embodiment, the memory 130 includes the information transfer module 10 shown in FIG. 1A and the associated modules or functions. The information transfer module 10 may be fully or partly implemented by hardware, firmware, or software, or any combination thereof. In addition, it may be fully or partly located in the memory 130. The information transfer module 10 may include functions, modules, programs, procedures, or methods that perform the functions described below. These functions may include, but are not limited to, the repository generator 25, the code generator 40, and the schema generator 60 described above.

The IOC 140 has a number of functionalities that are designed to support I/O functions. The IOC 140 may also be integrated into a chipset together or separate from the MC 120 to perform I/O functions. The IOC 140 may include a number of interface and I/O functions such as peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, wireless interconnect, direct media interface (DMI), etc.

The interconnect 145 provides interface to peripheral devices. The interconnect 145 may be point-to-point or connected to multiple devices. For clarity, not all interconnects are shown. It is contemplated that the interconnect 145 may include any interconnect or bus such as Peripheral Component Interconnect (PCI), PCI Express, Universal Serial Bus (USB), Small Computer System Interface (SCSI), serial SCSI, and Direct Media Interface (DMI), etc.

The mass storage interface 150 interfaces to mass storage devices to store archive information such as code, programs, files, data, and applications. The mass storage interface may include SCSI, serial SCSI, Advanced Technology Attachment (ATA) (parallel and/or serial), Integrated Drive Electronics (IDE), enhanced IDE, ATA Packet Interface (ATAPI), etc. The mass storage device may include compact disk (CD) read-only memory (ROM) 152, digital video/versatile disc (DVD) 153, floppy drive 154, and hard drive 155, tape drive 156, and any other magnetic or optic storage devices. The mass storage device provides a mechanism to read machine-accessible media that may contain the code or program to perform the information transfer tasks as described elsewhere.

The I/O devices 147₁ to 147_{K} may include any I/O devices to perform I/O functions. Examples of I/O devices 147₁ to 147_{K} include controller for input devices (e.g., keyboard, mouse, trackball, pointing device), media card (e.g., audio, video, graphic), and any other peripheral controllers.

The NIC 160 provides network connectivity to the system 100. The NIC 160 may generate interrupts as part of the processing of communication transactions. In one embodiment, the NIC 160 is compatible with both 32-bit and 64-bit peripheral component interconnect (PCI) bus standards. It is typically compliant with PCI local bus revision 2.2, PCI-X local bus revision 1.0, or PCI-Express standards. There may be more than one NIC 160 in the processing system. Typically, the NIC 160 supports standard Ethernet minimum and maximum frame sizes (64 to 1518 bytes), frame format, and Institute of Electronics and Electrical Engineers (IEEE) 802.2 Local Link Control (LLC) specifications. It may also support full-duplex Gigabit Ethernet interface, frame-based flow control, and other standards defining the physical layer and data link layer of wired Ethernet. It may support copper Gigabit Ethernet defined by IEEE 802.3ab or fiber-optic Gigabit Ethernet defined by IEEE 802.3z.

The NIC 160 may also be a host bus adapter (HBA) such as a Small Computer System Interface (SCSI) host adapter or a Fiber Channel (FC) host adapter. The SCSI host adapter may contain hardware and firmware on board to execute SCSI transactions or an adapter Basic Input/Output System (BIOS) to boot from a SCSI device or configure the SCSI host adapter. The FC host adapter may be used to interface to a Fiber Channel bus. It may operate at high speed (e.g., 2 Gbps) with auto speed negotiation with 1 Gbps Fiber Channel Storage Area Network (SANs). It may be supported by appropriate firmware or software to provide discovery, reporting, and management of local and remote HBAs with both in-band FC or out-of-band Internet Protocol (IP) support. It may have frame level multiplexing and out of order frame reassembly, on-board context cache for fabric support, and end-to-end data protection with hardware parity and cyclic redundancy code (CRC) support.

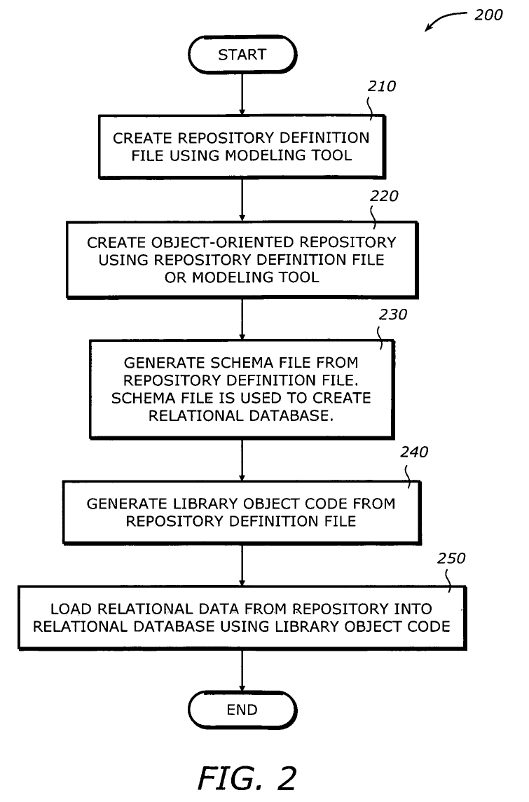

FIG. 2 is a flowchart illustrating a process 200 to transfer information from an object-oriented repository to a relational database according to one embodiment of the invention.

Upon START, the process 200 creates a repository definition file using a modeling tool (Block 210). The modeling tool may be a MOF-compliant modeling tool. Next, the process 200 creates an object-oriented repository using the repository definition file or the modeling tool (Block 220). This may be performed using an XMI format from the MOF modeling tool under an OMG standard. The MOF modeling tool has an XMI export capability.

Then, the process 200 generates a schema file from the repository definition file (Block 230). The schema file is used to create a relational database. Next, the process 200 generates a library object code from the repository definition file (Block 240). Then, the process 200 loads relational data from the repository into the relational database using the library object code (Block 250). The process 200 then terminates.

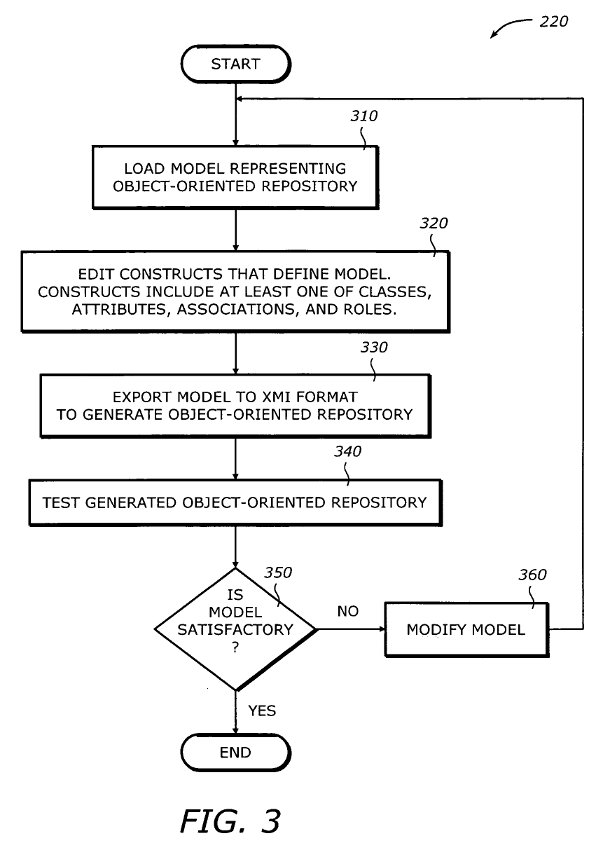

FIG. 3 is a flowchart illustrating the process 220 shown in FIG. 2 to create a repository definition file according to one embodiment of the invention.

Upon START, the process 220 loads a model representing the object-oriented repository (Block 310). Then, the process 220 edits constructs that define the model (Block 320). The constructs essentially form the repository definition file. The editing may include adding, deleting, and modifying the constructs. The constructs may include at least one of classes, attributes, associations, and roles.

Next, the process 220 exports the model to the XMI format to generate the repository (Block 330). Then, the process 220 tests the generated repository (Block 340). Next, the process 220 determines if the model corresponding to the generated repository is satisfactory (Block 350). If not, the process 220 modifies the model (Block 360) and returns to Block 310. Otherwise, the process 220 terminates.

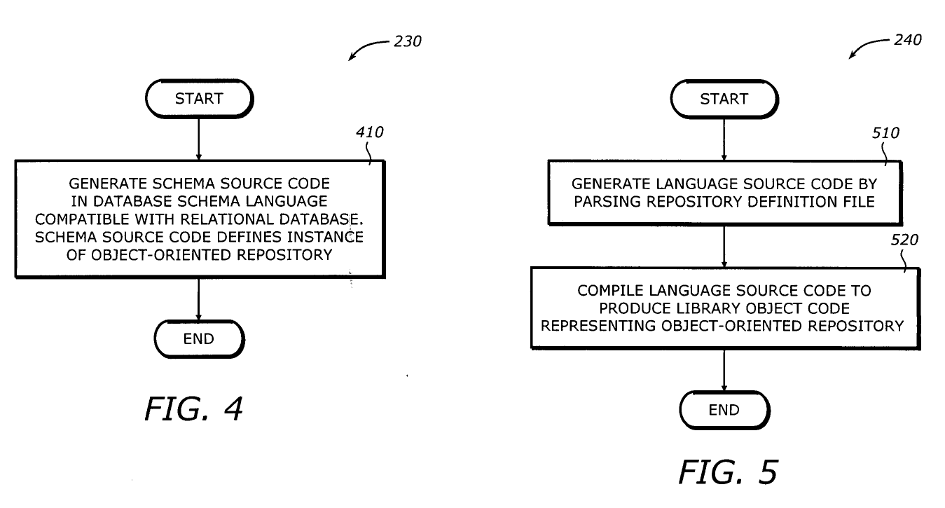

FIG. 4 is a flowchart illustrating the process 230 shown in FIG. 2 to generate a schema file according to one embodiment of the invention.

Upon START, the process 230 generates a schema source code in a database schema definition language compatible with the relational database (Block 410). The schema source code defines an instance of the object-oriented repository. When the schema source code is run, the relational database is created. The process 230 then terminates.

FIG. 5 is a flowchart illustrating the process 240 shown in FIG. 2 to generate the library object code according to one embodiment of the invention.

Upon START, the process 240 generates a language source code in an appropriate computer language in order to define an instance of the model in that language (Block 510). This may be performed by parsing the repository definition file.

Next, the process 240 compiles the language source code to produce the library object code representing the object-oriented repository (Block 520). The process 240 then terminates.

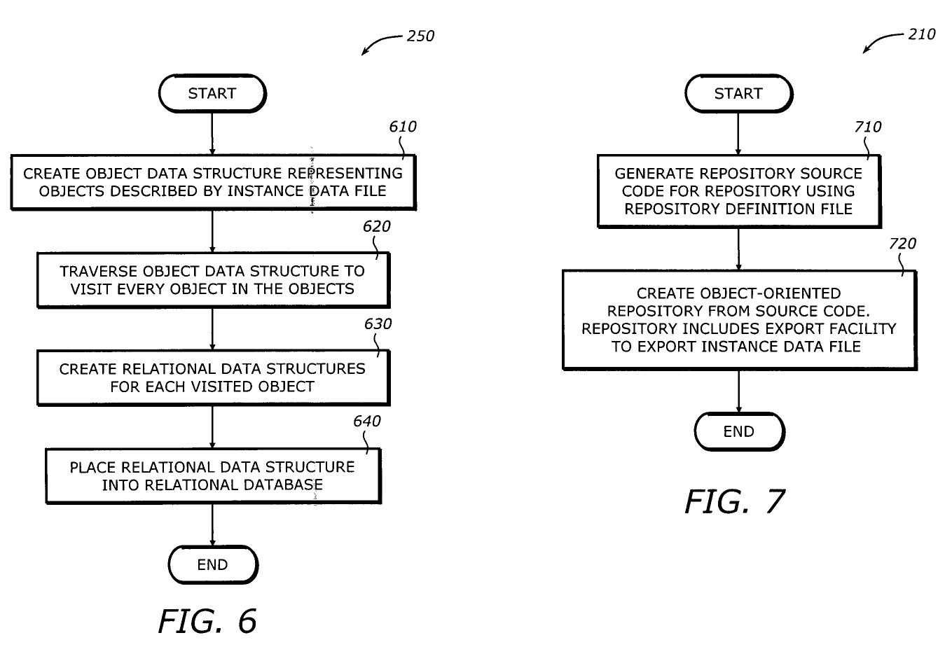

FIG. 6 is a flowchart illustrating the process 250 shown in FIG. 2 to load relational data from the repository into the relational database using the library object code, according to one embodiment of the invention.

Upon START, the process 250 creates an object data structure representing objects described by an instance data file (Block 610). This may be performed by parsing the instance data file. The instance data file may be exported by the object-oriented repository. Next, the process 250 traverses the object data structure to visit every object in the objects (Block 620).

Then, the process 250 creates a relational data structure for each visited object (Block 630). This may be performed by determining a meaning of a type of the visited object in terms of the relational database, and expressing the meaning in the relational data structure. Next, the process 250 places the relational data structure into the relational database (Block 640). This may be performed by making a call using an application programming interface (API) provided by the object-oriented repository. The process 250 then terminates.

FIG. 7 is a flowchart illustrating the process 210 to create a repository according to one embodiment of the invention.

Upon START, the process 210 generates a repository source code for the object-oriented repository using the repository definition file (Block 710). Next, the process 720 creates the object-oriented repository from the repository source code (Block 720). The repository includes an export facility to export the instance data file. The process 210 then terminates.

Elements of embodiments of the invention may be implemented by hardware, firmware, software or any combination thereof. The term hardware generally refers to an element having a physical structure such as electronic, electromagnetic, optical, electro-optical, mechanical, electro-mechanical parts, components, or devices, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory). Examples of firmware may include microcode, writable control store, micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments may be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable ROM (EROM), an erasable programmable ROM (EPROM), a floppy diskette, a compact disk (CD) ROM, an optical disk, a hard disk, a fiber optic medium, a radio frequency (RF) link, etc. The machine accessible medium may be embodied in an article of manufacture. The machine accessible medium may include data that, when accessed by a machine, cause the machine to perform the operations described above. The machine accessible medium may also include program code embedded therein. The program code may include machine readable code to perform the operations described above.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. An apparatus may include any combination of hardware, software, and firmware modules.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
creating a repository definition file using a modeling tool;
generating a schema file from the repository definition file, the schema file being used to create a relational database;
generating a library object code from the repository definition file; and
loading relational data from an object-oriented repository into the relational database using the library object code.

2. The method of claim 1 wherein creating the repository definition file comprises:
creating the repository definition file using an eXtensible Markup Language Metadata Interchange (XMI) format from a Meta Object Facility (MOF) modeling tool under an Object Management Group (OMG) standard, the MOF modeling tool having an XMI export capability.

3. The method of claim 2 wherein creating the repository definition file comprises:
loading a model representing the object-oriented repository;
editing constructs that define the model, the constructs including at least one of classes, attributes, associations, and roles;
exporting the model to the XMI format to generate the object-oriented repository; and
testing the generated object-oriented repository.

4. The method of claim 3 wherein creating the repository definition file further comprises:
modifying the model.

5. The method of claim 1 wherein generating the schema file comprises:
generating a schema source code in a database schema definition language compatible with the relational database, the schema source code defining an instance of the object-oriented repository.

6. The method of claim 1 wherein generating the library object code comprises:
generating a source code by parsing the repository definition file; and
compiling the source code to produce the library object code representing the object-oriented repository.

7. The method of claim 1 wherein loading the relational data comprises:
creating an object data structure representing objects described by an instance data file, the instance data file being exported by the object-oriented repository;
traversing the object data structure to visit every object in the objects;
creating a relational data structure for each visited object; and
placing the relational data structure into the relational database.

8. The method of claim 7 wherein creating the object data structure comprises:
parsing the exported instance data file.

9. The method of claim 7 wherein creating the relational data structure for each visited object comprises:
determining a meaning of a type of the visited object in terms of the relational database; and
expressing the meaning in the relational data structure.

10. The method of claim 7 wherein placing the relational data structure into the relational database comprises:
making a call using an application programming interface (API) provided by the object-oriented repository.

11. The method of claim 1 further comprising:
creating the object-oriented repository using the repository definition file or the modeling tool.

12. The method of claim 11 wherein creating the object-oriented repository comprises:
generating a repository source code for the object-oriented repository using the repository definition file; and
creating the object-oriented repository from the repository source code, the object-oriented repository including an export facility to export the instance data file.

13. An article of manufacture comprising:
a machine-accessible medium including data that, when accessed by a machine, causes the machine to perform operations comprising:
creating a repository definition file using a modeling tool;
generating a schema file from the repository definition file, the schema file being used to create a relational database;
generating a library object code from the repository definition file; and
loading relational data from an object-oriented repository into the relational database using the library object code.

14. The article of manufacture of claim 13 wherein the data causing the machine to perform creating the repository definition file comprises data that, when accessed by a machine, cause the machine to perform operations comprising:
creating the repository definition file using an eXtensible Markup Language Metadata Interchange (XMI) format from a Meta Object Facility (MOF) modeling tool under an Object Management Group (OMG) standard, the MOF modeling tool having an XMI export capability.

15. The article of manufacture of claim 14 wherein the data causing the machine to perform creating the repository definition file comprises data that, when accessed by a machine, cause the machine to perform operations comprising:
loading a model representing the object-oriented repository;
editing constructs that define the model, the constructs including at least one of classes, attributes, associations, and roles;
exporting the model to the XMI format to generate the object-oriented repository; and
testing the generated object-oriented repository.

16. The article of manufacture of claim 15 wherein the data causing the machine to perform creating the repository definition file further comprises data that, when accessed by a machine, cause the machine to perform operations comprising:
modifying the model.

17. The article of manufacture of claim 13 wherein the data causing the machine to perform generating the schema file comprises data that, when accessed by a machine, cause the machine to perform operations comprising:
generating a schema source code in a database schema definition language compatible with the relational database, the schema source code defining an instance of the object-oriented repository.

18. The article of manufacture of claim 13 wherein the data causing the machine to perform generating the library object code comprises data that, when accessed by a machine, cause the machine to perform operations comprising:
generating a source code by parsing the repository definition file; and
compiling the source code to produce the library object code representing the object-oriented repository.

19. The article of manufacture of claim 13 wherein the data causing the machine to perform loading the relational data comprises data that, when accessed by a machine, cause the machine to perform operations comprising:
creating an object data structure representing objects described by an instance data file, the instance data file being exported by the object-oriented repository;
traversing the object data structure to visit every object in the objects;
creating a relational data structure for each visited object; and
placing the relational data structure into the relational database.

20. The article of manufacture of claim 19 wherein the data causing the machine to perform creating the object data structure comprises data that, when accessed by a machine, cause the machine to perform operations comprising:
parsing the exported instance data file.

21. The article of manufacture of claim 19 wherein the data causing the machine to perform creating the relational data structure for each visited object comprises data that, when accessed by a machine, cause the machine to perform operations comprising:
determining a meaning of a type of the visited object in terms of the relational database; and
expressing the meaning in the relational data structure.

22. The article of manufacture of claim 19 wherein the data causing the machine to perform placing the relational data structure comprises data that, when accessed by a machine, cause the machine to perform operations comprising:
making a call using an application programming interface (API) provided by the object-oriented repository.

23. The article of manufacture of claim 14 the data further comprises data that, when accessed by a machine, cause the machine to perform operations comprising:
creating the object-oriented repository using the repository definition file or the modeling tool.

24. The article of manufacture of claim 23 wherein the data causing the machine to perform creating the object-oriented repository comprises data that, when accessed by a machine, cause the machine to perform operations comprising:
generating a repository source code for the object-oriented repository using the repository definition file; and
creating the object-oriented repository from the repository source code, the object-oriented repository including an export facility to export the instance data file.

25. A system comprising:
a modeling tool to create a repository definition file; and
an information transfer module coupled to the modeling tool, the information transfer module comprising:
a schema generator to generate a schema file from the repository definition file, the schema file being used to create a relational database,
a code generator to generate a library object code from the repository definition file, and
a loader to load relational data from an object-oriented repository into the relational database using the library object code.

26. The system of claim 25 wherein model tool creates the repository definition file using an eXtensible Markup Language Metadata Interchange (XMI) format from a Meta Object Facility (MOF) modeling tool under an Object Management Group (OMG) standard, the MOF modeling tool having an XMI export capability.

27. The system of claim 26 wherein the model tool creates the repository definition file by loading a model representing the object-oriented repository, editing constructs that define the model, exporting the model to the XMI format to generate the object-oriented repository, and testing the generated object-oriented repository; wherein the constructs include at least one of classes, attributes, associations, and roles.

28. The system of claim 27 wherein the model tool creates the repository definition file by further modifying the model.

29. The system of claim 25 wherein the schema generator generates a schema source code in a database schema definition language compatible with the relational database, the schema source code defining an instance of the object-oriented repository.

30. The system of claim 25 wherein the code generator generates a source code by parsing the repository definition file, the source code being compiled to produce the library object code representing the object-oriented repository.

31. The system of claim 25 wherein the loader creates an object data structure representing objects described by an instance data file, traverses the object data structure to visit every object in the objects, creates a relational data structure for each visited object, and places the relational data structure into the relational database; wherein the instance data file is exported by the object-oriented repository.

32. The system of claim 31 wherein the loader creates the object data structure by parsing the exported instance data file.

33. The system of claim 31 wherein the loader creates the relational data structure by determining a meaning of a type of the visited object in terms of the relational database, and expressing the meaning in the relational data structure.

34. The system of claim 31 wherein the loader places the relational data structure by making a call using an application programming interface (API) provided by the object-oriented repository.

35. The system of claim 25 wherein the information transfer module further comprises:
a repository generator to create the object-oriented repository using the repository definition file.

36. The system of claim 35 wherein the repository generator generates a repository source code for the object-oriented repository using the repository definition file, and creates the object-oriented repository from the repository source code, the object-oriented repository including an export facility to export the instance data file.
